(19) United States
(12) Patent Application Publication
(10) Pub. No.: US 2002/0181730 A1
(43) Pub. Date: Dec. 5, 2002

(54) ELECTROMAGNETIC AUDIO TRANSDUCER WITH MICRO ADJUSTABLE CORE

(76) Inventor: William J. Ashworth, Altamonte Springs, FL (US)

Correspondence Address: William J. Ashworth, 1012 Ashworth Cove, Altamonte Springs, FL, 32714, US

(21) Appl. No.: 09/873,437

(22) Filed: Jun. 4, 2001

(51) Int. Cl. H04R 1/00; H04R 9/06

(52) U.S. Cl. 381/411; 381/396; 381/407

(57) ABSTRACT

An audio transducer having simple and single means to micro adjust the air gap between the driving element and the driven element.

### TECHNICAL FIELD

This invention relates to electromagnetic audio transducers with a movable and adjustable magnetic core where the air gap between the magnetic core and its magnetizable armature can be adjusted or tuned to its optimum micro spacing with a single and simple adjusting means while the transducer is in operation.

### BACKGROUND OF THE INVENTION

Electromagnet transducers with adjustable magnetic cores are well known to the art. For instance the Ashworth U.S. Pat. No. 3,449,531 teaches two methods of adjusting the air gap between the magnetizable core and the magnetizable armature. One method shown requires four screw to be adjusted with nuts and a simple micro adjustment of the air gap spacing would not be possible with this arrangement. The other method shown in this patent teaches ascending axial cam tracks that the transducer core mounting plate rides on. To make an adjustment, it is necessary to turn the core mounting plate by hand and a precise, accurate micro adjustments cannot be made with this arrangement as can be made with the present invention. The Ashworth U.S. Pat. No. 4,151,379 teaches another method of adjusting the air gap between the magnetizable core and magnetizable armature. A precise micro adjustment cannot be made with the arrangement shown in this patent. The Ashworth U.S. Pat. No. 5,706,358 teaches still another method of adjusting the air gap. The flexible adjustable bumper attached to the transducer armature does not allow a precise micro air gap adjustment to be made. In electromagnetic transducers the air gap between the transducer core and armature is extremely critical in determining the operating efficiency of the transducer. When the amount of power supplied to the transducer is low the air gap between the core and armature must be smaller to obtain maximum sound volume and performance. When a greater amount of power is applied to the transducer, the air gap between the magnetic driving core and the magnetizable driven armature should be wider in order to prevent the air gap from closing and causing a chattering sound, when certain frequencies are supplied to the transducer. In order to obtain optimum performance of an electromagnetic transducer, the spacing of the air gap between the magnetizable core and the magnetizable armature must be precisely adjusted by the user when the transducer is in operation. None of the above cited prior art will allow a precise micro in and out movement of the magnetizable core, in relation to the transducer armature core, with a single and simple adjustment that can made by the user while the transducer is in operation, as does the present invention.

### SUMMARY OF THE INVENTION

The present invention provides a method of easily and precisely adjusting the air gap between the magnetizable core and the magnetizable armature of an electromagnet transducer. A single and simple adjustment can easily be made by the user after the driver portion of the transducer has been affixed to the armature and the transducer is in operation. The present invention was primarily developed so the exterior metal of cars, vans and trucks could be vibrated and radiate audible sound from the outside of the vehicle and be used as an advertising medium or for any other desired purpose. The metal of the vehicle is used as the magnetizable transducer armature. When vibrated by the driver portion of the transducer, the metal will radiate sound. into the area surrounding the vehicle. If a transducer or transducers are mounted inside the car trunk, it will appear that the sound will be coming from inside the trunk. A voice cassette tape may be used with a car radio cassette player so that it will appear that a person or persons are in the trunk. The reason that a precise air gap adjustable means is necessary between the driver portion of the transducer and the armature or vehicle metal, is that usually the vehicle metal the driver portion is attached to, will usually not be flat but curved. This shape of the vehicle metal will require a transducer core adjustment by the user after the driver portion of the transducer is attached the vehicle metal and audio power is applied to the transducer. Also, the car radio or tape player may be a low wattage unit and will not produce enough outside sound volume unless the air gap has a very close spacing. For optimum results the air gap adjustment must be made by the user with the driver portion of the transducer attached to the vehicle and operating with power applied from the power source. The power source would usually be a cassette tape player, preferably one with automatic reverse so a continuos unbroken message could be played. The present invention can also be used for other purposes than for use with a motor vehicle. The present invention may have an armature that is connected to any other vibratile surface, causing that surface to radiate sound as shown in the above referenced Ashworth patents. Different shapes and sizes of the magnetizable armature will produce different frequency responses.

### BRIEF DESCRIPTION OF THE DRAWINGS

FIG. 1 is a side view of the invention.

FIG. 2. is a top view of the invention.

FIG. 3. is a sectional view of the invention taken along A-A of FIG. 1.

FIG. 4. is a schematic drawing showing the transducer connected to a power source.

FIG. 5 is a side view of the present invention showing it's armature attached to a sounding board.

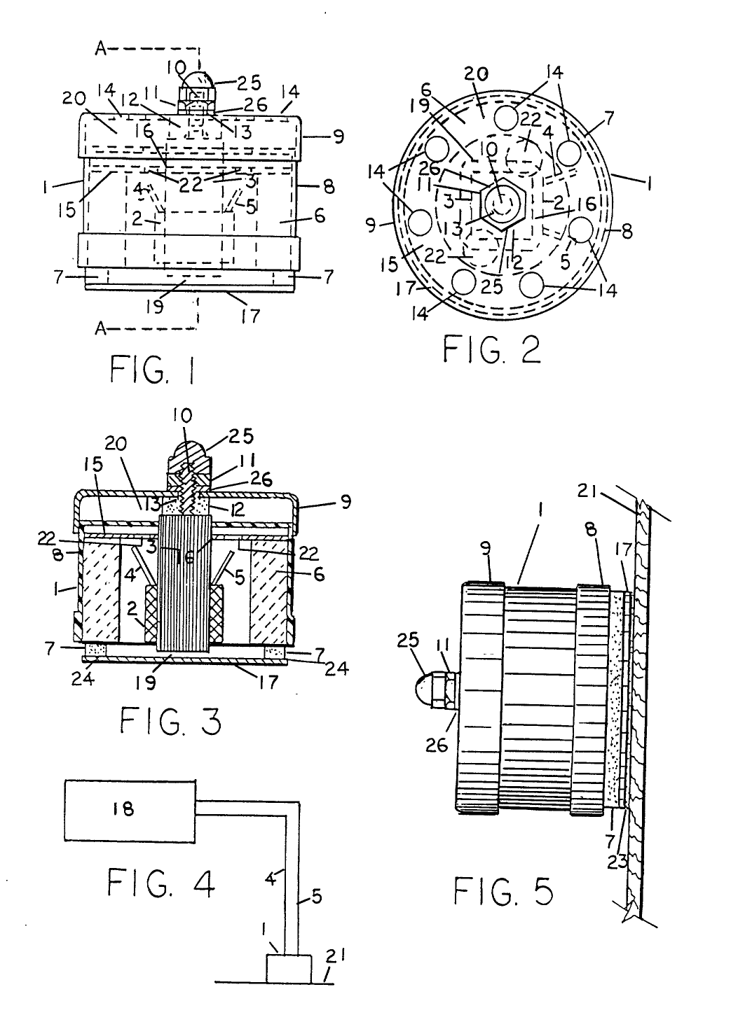

### DESCRIPTION OF THE PREFERRED EMBODIMENT OF THE INVENTION

The primary object of the present invention is to provide a simple and efficient method of causing a vehicle such as a car, van or truck to radiate audible sound from its outer surface into a surrounding area and be used as an advertising medium, or for any other useful purpose, but is not limited to that purpose and may be attached to other surfaces or sounding boards for the purpose of producing sound.

Transducer 1 consists of coil 2, core 3, coil leads 4 and 5, permanent magnet 6, resilient spacer 7, magnet cover 8, magnet cover cap 9, screw 10, nut 11, washer 26, cap nut 25, rubber compression pad 12, vent holes 14 in magnet cover cap 9, core guide plate 15 and vent holes 22 in plate 15 and magnetizable armature 17. Coil 2 is positioned on core 3 and the core is inserted through center hole 16 of core guide plate 15. Screw 10 is attached to the upper end of core 6 by a suitable means such as with epoxy. Core guide plate 15 is cemented to magnet 6 with a suitable cement such as contact cement or epoxy. A suitable cement such as epoxy is placed around the inside of magnet cover 8 and then the magnet 6, core guide plate 15, and coil 2 and core 3 are pressed into the magnet cover 8. Compression pad 12 is optional and may be made of a compressible and expandable rubber or can be a spring or can not be used at all. The magnetic attraction between the core 3 and armature 17 will hold the core in place without compression pad 12. A hole in compression pad 12, if used is positioned over screw 10 so it rests against core 3. Cap 9 may be made of metal and is placed on top of magnet cover 8 with screw 10 extending through the center hole 13, in cap 9. Cap 9 is then force pressed down over cover 8 compressing, compression pad or spring 12 slightly if used. Washer 26 may be made from a non metallic material and is placed over screw 10 against cap 9. Nut 11 is then screwed onto screw 10. Turning nut 11 provides the means for micro adjusting the air gap between core 3 and armature 17. Cap nut 25 is screwed onto screw 10 for decorative purposes and can also serve to lock nut 11 in place. Resilient pad or pads 7 may be made of soft rubber or any other suitable material and may be attached to the magnet 6 with a suitable cement such as contact cement. For low power applications a single round donut shaped pad 7 with a hole in it's center is suitable for use. For applications that requires enough driving power that will generate considerable heat inside the transducer, several pads rather than one donut shaped pad should positioned around magnet 6, with spaces between them so outside air can move through the spaces between pads 7, through the inside of the transducer magnet 6 around core 3 and coil 2 and through the openings 22 in core guide plate 15, then through opening 16 in magnet cover 8 and then through the holes 14 in metal cap 9. The treble sound generated by armature 17 also passes through the inner portion of transducer 1, and out of holes 14 in magnet cover cap 9. Core guide plate 15 also vibrates and generates treble sounds that pass through holes 14 in cap 9. The outer side of resilient pad or pads 7 may be coated with a self sticking adhesive 24 for attaching the driver portion of the transducer to a magnetizable armature 17 such as the metal of an automobile, truck or van or any other magnetizable armature. Coil lead wires 4 and 5 are connected to an electrical power source 18 such as a cassette tape player or other sound source. When the power source is in operation, an electrical signal is supplied to coil 2 through coil leads 4 and 5, generating an alternating magnetic force against armature 17. This causes armature 17 to vibrate and generate sound. The correct air gap 19 adjustment can be made by either tightening or loosening nut 11. If the nut 11 is tightened, core 3 will be pulled through core guide plate 15 into the cap 9 space 20, compressing, compression pad or spring 12 more tightly, if used. This will widen the air gap between core 3 and armature 17. If nut 11 is loosened, compression member 12 will push core 3 downward toward armature 17 narrowing air gap 19. The use of compression pad or spring 12 is optional because the magnetic attraction between core 3 and armature 17 causes a pulling tension to be present at nut 11 against cap 9. Tightening or loosening of nut 11 will adjust the air gap spacing between magnet 6 and armature 17 whether or not compression pad or spring 12 is used. As previously stated, this invention was primarily developed for use with motor vehicles but it can used a driver for any other type sounding board 21 for the production of sound. Armature 17 can be of any suitable configuration or such as shown in the above referenced Ashworth patents. Different configurations and shapes and sizes of armature 17 produces different frequency responses. Armature 17 can be attached to a sounding board with double faced 4tape 23, or any suitable glue or screws. The armature 17 method of fastening to a sounding board will be determined by the configuration and shape of armature 17.

While the principals of the invention have been made clear in illustrative embodiments, it will be immediately obvious to those skilled in the art that many modifications of structure, arrangement, proportions, the elements, materials, and components used in the practice of this invention, and otherwise, which are particularly adapted to specific environments and operative requirements can be made without departing from those principals. The following claims are intended to cover and embrace any or all of such modifications, within the limits of the true spirit and scope of the invention.

What I claim is:

1. A transducer apparatus for the production of sound comprising a permanent magnet biasing means, a driving means consisting of a magnetizable core with wire coiled about said core and a magnetizable driven means positioned in a spaced relationship to said driving means, with said driving means movable longitudinally toward or away from said driven means, with said driving means having threaded means located at it's end opposite said driven means, whereby said threaded means extends through said core's support means, with a threaded nut positioned on said threaded means that extends through said core support means, with said driving means and said driven means being magnetically attracted to each other thereby pulling said nut against said core support means and when said nut is turned in one direction said core will move longitudinally away from said driven means and when said nut is turned in the opposite direction said core will be magnetically pulled longitudinally toward said driven means thereby providing means for micro adjusting said spaced relationship between said driving element and said driven element with a single adjusting means

2. A transducer apparatus according to claim 1, where compressible and expandable means are deposed between said core support means and said core.

3. A transducer apparatus according to claim 1 where said driven means is the magnetizable metal of a motor vehicle.

4. A transducer apparatus according to claim 2 where said driven means is the magnetizable metal of a motor vehicle.

5. A transducer apparatus according to claim 1 where said driven means is in direct contact with a second vibratile means for the production of sound.

6. A transducer apparatus according to claim 2 where said driven element is in direct contact with a second vibratile means for the production of sound

7. A transducer apparatus according to claim 1 where treble tones generated within said transducer are propelled out of the end of said transducer opposite said driven element into a listening area.

8. A transducer apparatus according to claim 2 where treble tones generated within said transducer are propelled out of the end of said transducer opposite said driven element into a listening area.
board with double faced 4tape 23, or any suitable glue or screws. The armature 17 method of fastening to a sounding board will be determined by the configuration and shape of armature 17.
While the principals of the invention have been made clear in illustrative embodiments, it will be immediately obvious to those skilled in the art that many modifications of structure, arrangement, proportions, the elements, materials, and components used in the practice of this invention, and otherwise, which are particularly adapted to specific environments and operative requirements can be made without departing from those principals. The following claims are intended to cover and embrace any or all of such modifications, within the limits of the true spirit and scope of the invention.
